(19) United States
(12) Patent Application Publication
(10) Pub. No.: US 2005/0270440 A1
(43) Pub. Date: Dec. 8, 2005

(54) Liquid crystal display and light module thereof

(75) Inventors: Chun-Yuan Chen, Kaohsiung (TW); Hui-Kai Chou, Taipei City (TW)

Correspondence Address: GENESIS/GENUS LAW GROUP, 12760 HIGH BLUFF DRIVE, SUITE 300, SAN DIEGO, CA, 92130, US

(73) Assignee: AU OPTRONICS CORPORATION

(21) Appl. No.: 10/956,093

(22) Filed: Oct. 4, 2004

(30) Foreign Application Priority Data
Jun. 4, 2004 (TW) 93116189

(51) Int. Cl. G02F 1/1335

(52) U.S. Cl. 349/64

(57) ABSTRACT

A light module and a LCD (Liquid Crystal Display) are provided. The light module is applied to manufacture the LCD. The light module includes a plate light source and a diffuser. The plate light source includes an emitting surface, wherein the diffuser is set on the emitting surface.

### BACKGROUND OF THE INVENTION

1. Field of the Invention

The present invention relates to an liquid crystal display and a light module thereof, and more particularly to a light module including a diffuser.

2. Description of Related Art

The development of the digital technology affects the work and the life of people living in the 21 century. One kind of digital technology instrument, i.e. liquid crystal display, is popularly applied to the daily life of people. The liquid-crystal panels of the liquid crystal display industry can be applied to notebook computers, monitors, portability consumable image products, music products, cell phones and liquid-crystal televisions.

To assemble liquid crystal display, a diffusing plate has to be assembled on a back light module to diffuse the light emitted from the back light module to produce a nice image after light passing through a liquid crystal panel. As shown in FIG. 1, a diffusing plate 13 is assembled inside an liquid crystal display to diffuse the light emitted from a plate light source 11. The diffusing plate 13 makes the light uniform.

However, most of the diffusing plates 13 are made of glass. If the plate light source 11 with the diffusing plate 13 set on, is also made of glass, the process for assembling the diffusing plate 13 on the plate light source 11 is difficult. Furthermore, the light passing through the diffusing plate 13 may be non-uniform if the diffusing plate 13 is not fastened well on the plate light source 11 due to some faults during the assembling process. Another disadvantage is that diffusing plate is set on many different kinds of plate light sources or many different kinds of back light modules. Thus the quality of the light passing through the diffusing plate may be downgraded because the design of the diffusing plate is not fit for the plate light source.

Thus it is necessary to develop a light module and an liquid crystal display to make the process more convenient and prevent the light from being non-uniform.

### SUMMARY OF THE INVENTION

It is therefore an object of the present invention to make the process for assembling liquid crystal display more convenient and overcome the disadvantage.

It is another object of the present invention to provide a light module including a diffuser to make the light emitted from a light module more uniform.

It is still an object of the present invention to provide a light module including a diffuser to improve the quality of the light emitted from the light module, wherein the diffuser is especially designed according to a plate light source of the light module.

In accordance with the present invention, these objects are accomplished by providing a light module to be applied in an liquid crystal display, an optical instrument or other optical products. The light module of the present invention includes a plate light source having an emitting surface with a diffuser set on.

### BRIEF DESCRIPTION OF THE DRAWINGS

The foregoing aspects and many of the attendant advantages of this invention will become more readily appreciated and better understood by reference to the following detailed description, when taken with the accompanying drawings, wherein:

FIG. 1 illustrates a schematic diagram of a conventional plate light source with a diffusing plate set on;

FIG. 2A illustrates a schematic diagram of a light module according to the first embodiment of the present invention;

FIG. 2B illustrates a schematic diagram of a light module according to the second embodiment of the present invention;

FIG. 2C illustrates a schematic diagram of a light module according to the third embodiment of the present invention;

FIG. 3A illustrates a schematic diagram of a liquid crystal display incorporating a light module according to the fourth embodiment of the present invention; and

FIG. 3B illustrates a schematic diagram of a liquid crystal display incorporating a light module according to the fifth embodiment of the present invention.

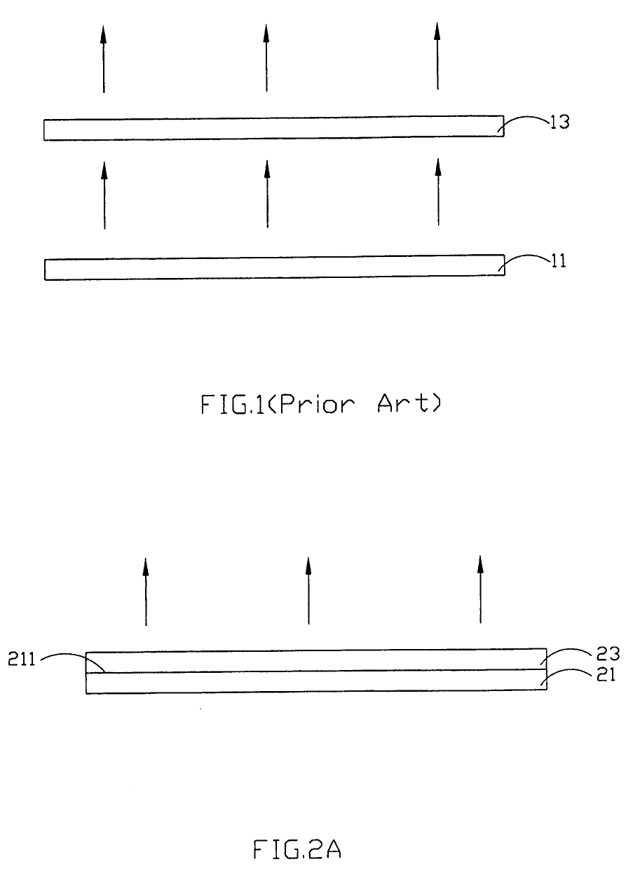

### DESCRIPTION OF THE PREFERRED EMBODIMENT

These preferred embodiments of the present invention are now described in great detail. Nevertheless, it should be recognized that the present invention can be practiced in a wide range of embodiments besides those explicitly described, and the scope of the present invention is expressly not limited except as specified in the accompanying claims.

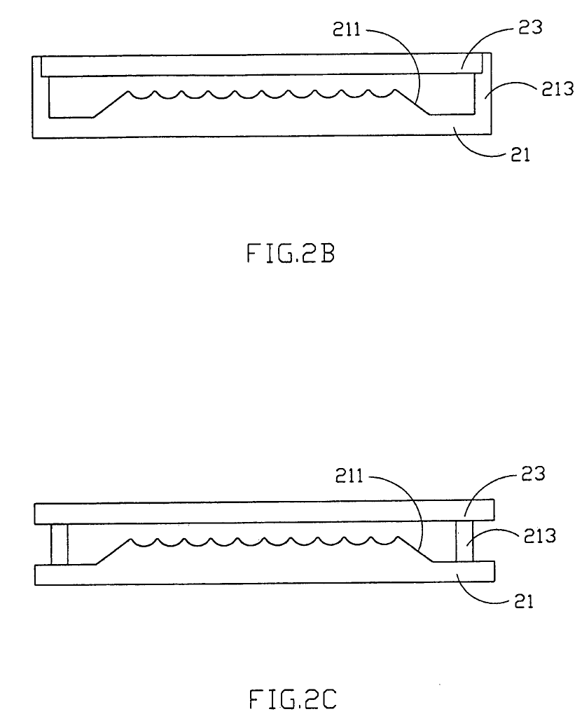

As shown in FIG. 2A, the first embodiment of the present invention provides a light module including a plate light source 21 and a diffuser 23, wherein the plate light source 21 has an emitting surface 211. The diffuser 23 is set on the emitting surface 211. When operating the plate light source 21 to emit a light through the emitting surface 211, the diffuser 23 set on the emitting surface 211 diffuses the light to scatter the light emitted from the emitting surface 211 to modulate the light.

The light module including the diffuser 23 directly attached to the emitting surface 211 of the plate light source 21 of the present invention makes the process for assembling the optical instruments or other optical products more convenient, and reduces the difficulty of the process. The light module of the present invention emits the uniform light without additional diffusing plate 13. Thus the process of assembling the optical instruments or other optical products becomes more convenient and less difficulty. Furthermore, the quality of the light emitted from the light module of the present invention is nice and stable, because each diffuser 23 is especially designed according to the plate light source 21 with the diffuser 23 set on. The light module of the present invention overcomes the disadvantage of the conventional light module.

It is to be understood that many modifications and variations of the elements of the light module are possible in light of the above teachings. For example, the diffuser 23 of the first embodiment is attached to the emitting surface 211. However, the method of setting the diffuser 23 on the plate light source 21 changes according to the different design of the present light module.

As shown in FIG. 2B, the light module includes a plate light source 21, a diffuser 23 and a joint structure 213, wherein the emitting surface 211 of the plate light source 21 is designed to be an uneven surface. The diffuser 23 is jointed to the joint structure 213, wherein the plate light source 21 and the joint structure 213 are manufactured as a whole. The diffuser 23 does not contact with the emitting surface 211 to better the light-diffusing efficiency and the cooling efficiency due to the space formed between the diffuser 23 and the emitting surface 211. However, although the plate light source 21 and the joint structure 213 are manufactured as a whole of the second embodiment, the joint structure 213 may be set on the plate light source 21 as a different structure of different embodiments of the present invention.

As shown in FIG. 2C, a plurality of joint structures 213 are set on a plate light source 21 of the third embodiment of the present invention. A diffuser 23 is jointed to the joint structures 213 to set on an emitting surface 211 of the plate light source 21.

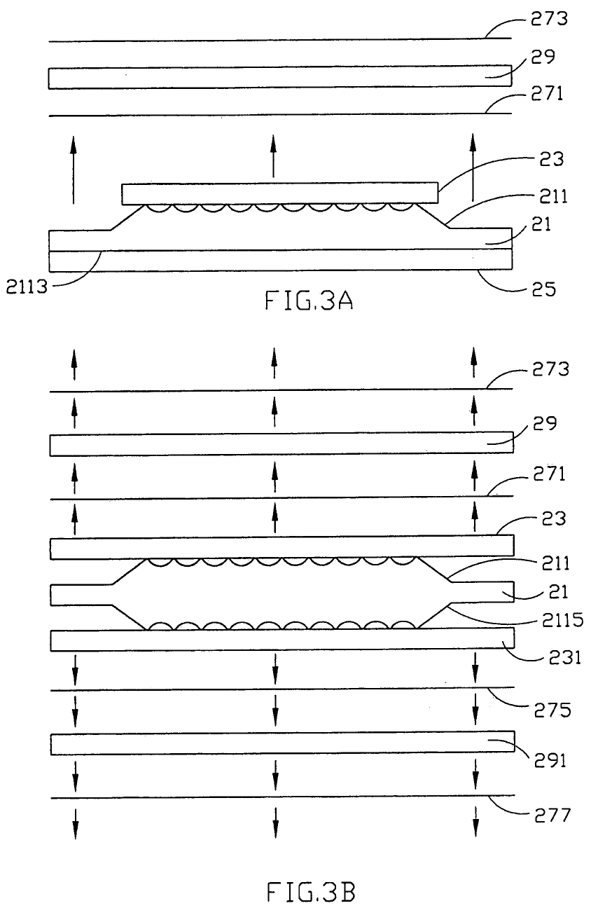

As shown in FIG. 3A, a diffuser 23 is attached to an emitting surface 211 of a plate light source 21 of the fourth embodiment of the present invention. Furthermore, the plate light source 21 includes a reflector 25. The reflector 25 may be formed on a surface 2113 of the plate light source 21, wherein the surface 2113 is opposite to the emitting surface 211. The reflector 25 may be electroplated on the surface 2113. Styles of the reflector 25 may be changed in different embodiments of the present invention.

The light module of the present invention can be applied to many kinds of the optical instruments or other optical products. As shown in FIG. 3A, the light module of the fourth embodiment of the present invention is applied to liquid crystal displays. Liquid crystal displays include the light module, an liquid crystal layer 29; a first polarizer 271 and a second polarizer 273. The second polarizer 273 is set on a side of the light module. The liquid crystal layer 29 is set between the light module and the second polarizer 273. The first polarizer 271 is set between the liquid crystal layer 29 and the light module. The plate light source 21 further includes a reflector 25, wherein the emitting surface 211 is set between the reflector 25 and the first polarizer 271.

When operating the light module of the present invention, a portion of the light emitted from the emitting surface 211 set between the reflector 25, and the first polarizer 271 is emitted through the diffuser 23. Another portion of the light emitted from the emitting surface 211 is emitted to the first polarizer 271, the liquid crystal layer 29 and the second polarizer 273. Other portion of the light is directly emitted to the reflector 25 or reflected to the reflector 25. The reflector 25 reflects the light to the first polarizer 271, the liquid crystal layer 29 and the second polarizer 273.

When assembling liquid crystal displays of the present invention, it's not necessary to assemble another diffusing plate inside liquid crystal displays due to the light module including the plate light source 21, the diffuser 23 and the reflector 25. The light module including the diffuser 23 and the reflector 25 makes the process for assembling liquid crystal displays more convenient because the diffuser 23 is already assembled inside the light module. The quality of the light emitted from the light module of the present invention is improve because the diffuser 23 is especially designed according to the plate light source 21 of the light module.

As shown in FIG. 3B, the light module of the fifth embodiment of the present invention has a back emitting surface 2115 opposite to an emitting surface 211, and a back diffuser 231 set on the back emitting surface 2115. Furthermore, the light module of the fifth embodiment is applied to liquid crystal displays. Liquid crystal displays further include a back liquid crystal layer 291, a third polarizer 275 and a fourth polarizer 277. The back liquid crystal layer 291 is set on a side of the back emitting surface 2115. The third polarizer 275 and the fourth polarizer 277 are set on two sides of the back liquid crystal layer 291.

When operating the light module of the fifth embodiment, the plate light source 21 emits the light to a diffuser 23 and the back diffuser 231 through the emitting surface 211 and the back emitting surface 2115, respectively. The plate light source 21 emits the light to display an image through the back emitting surface 2115, the back diffuser 231 set on the back emitting surface 2115, the third polarizer 275, the back liquid crystal layer 291 and a fourth polarizer 277.

When assembling liquid crystal displays including the light module of the fifth embodiment, it's not necessary to assemble other diffusing plates inside liquid crystal displays due to the light module including the diffuser 23 and the back diffuser 2115. Thus the process for assembling liquid crystal displays is more convenient due to the light module of the present. Furthermore, the light emitted from the light module of the present invention is very uniform because the diffuser 23 and the back diffuser 231 are designed according to the plate light source 21.

A light module of the present invention includes a diffuser especially designed according to a plate light source, set on the plate light source of the light module to make the light emitted from the plate light source as uniform as possible. The light module of the present invention is applied to many kinds of optical instruments and other optical products, ex. liquid crystal displays, to make the process of assembling the optical instruments and other optical products more convenient, and the light emitted from the light module more uniform.

Obviously, many modifications and variations of the present invention are possible in light of the above teachings. It is to be understood that within the scope of the appended claims, the present invention may be practiced other than as specifically described herein.

Although the specific embodiments have been illustrated and described, it will be obvious to those skilled in the art that various modifications may be made without departing from the spirit and the scope of the invention as hereinafter claimed.

1. A light module, comprising:
a light source having an emitting surface;
a joint structure disposed on said emitting surface; and
a diffuser disposed on said emitting surface and jointed to said joint structure.

2. The light module according to claim 1, wherein said diffuser is stuck on said emitting surface.

3. The light module according to claim 1, further comprising a reflector disposed on a surface opposite to said emitting surface.

4. The light module according to claim 3, wherein the reflector is electroplated on the surface opposite to said emitting surface.

5. The light module according to claim 1, further comprising a back diffuser disposed on a back emitting surface opposite to said emitting surface.

6. The light module according to claim 1, wherein said light source and said joint structure are formed as a whole.

7. The light module according to claim 1, wherein the light source is a plate light source.

8. An liquid crystal display, comprising:
a light module, wherein the light module comprises:
a light source having an emitting surface;
a joint structure disposed on said emitting surface; and
a diffuser disposed on said emitting surface and jointed to said joint structure.;
a second polarizer adjacent to said light module;
an liquid crystal layer disposed between said light module and said second polarizer; and
a first polarizer disposed between said liquid crystal layer and said light module.

9. An liquid crystal display according to claim 8, wherein said light module further includes a reflector, and said emitting surface is between said reflector and said first polarizer.

10. An liquid crystal display according to claim 8, wherein said light source has a back emitting surface opposite to said emitting surface.

11. An liquid crystal display according to claim 10, further comprising a back diffuser disposed on said back emitting surface.

12. An liquid crystal display according to claim 10, further comprising a back liquid crystal layer disposed on a side of said back emitting surface, a third polarizer and a fourth polarizer, wherein said back liquid crystal layer is between said third polarizer and said fourth polarizer.
